(19) United States
(12) Patent Application Publication
(10) Pub. No.: US 2004/0093502 A1
(43) Pub. Date: May 13, 2004

(54) Methods and apparatus for passing authentication between users

(76) Inventors: Stan D. Shurygailo, Boulder, CO (US); Erika B. Klein, Superior, CO (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/294,504

(22) Filed: Nov. 13, 2002

(51) Int. Cl. H04L 9/00

(52) U.S. Cl. 713/183; 713/202

(57) ABSTRACT

Disclosed are novel methods and apparatus for provision of efficient, effective, and/or flexible passing of authentication between users. In accordance with an embodiment of the present invention, a method of passing authentication between a plurality of users is disclosed. The method includes: creating a token; associating the token with an entitlement; passing the token to a target user without having to first establish that the target user is a registered user; the target user presenting the token for redemption; authenticating the token; and if the token is authenticated, providing the entitlement to the target user in a same session.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright © 2002, Sun Microsystems, Inc., All Rights Reserved.

### FIELD OF INVENTION

The present invention generally relates to the field of authentication. More specifically, an embodiment of the present invention provides for passing authentication between users.

### BACKGROUND OF INVENTION

As the Internet becomes increasingly a part of everyday life, the number of users utilizing the Web to perform commercial transactions (such as e-commerce) is growing exponentially. The always-available services through Web pages are contributing to this growth. For example, a user in a different time zone than a service provider does not have to worry about the customer service hours of operation when utilizing a Web site-based customer service tool. As a result of its many benefits, e-commerce is envisioned to become more commonplace than traditional commerce in the coming years.

Larger companies are also actively participating in the commercial use of the Internet. One problem with today's Internet-based solutions, however, is that an authenticated entitlement is not readily transferable between users or entities. For example, to pass an entitlement from an originating user to a receiving user, the target user needs to already be a registered user on the system utilized by the originating user. In other words, to pass authentication, the originating or receiving users need to first create an account (or provide a set of data) for the receiving user. Once the account is created, the originating user may pass an entitlement to the receiving user. The steps involved in traditional authentication of users can be cumbersome and time-consuming.

Also, the traditional authentication transfer methods allow transfer within the system that authorizes the receiving user. This limitation can be a problem because such internal system transfers may not always be the most efficient, flexible, or convenient way of transferring authentication between users.

Furthermore, the limitations imposed by the traditional system transfers prevent free commercial transactions by resellers. For example, resellers who are in the business of buying from a seller and selling to a purchaser are not able to readily pass authentication due to, for example, the limitations posed by the traditional authentication transfer systems.

### SUMMARY OF INVENTION

The present invention, which may be implemented utilizing a general-purpose digital computer, in certain embodiments of the present invention, includes novel methods and apparatus to provide efficient, effective, and/or flexible passage of authentication between users. In accordance with an embodiment of the present invention, a method of passing authentication between a plurality of users is disclosed. The method includes: creating a token; associating the token with an entitlement; passing the token to a target user without having to first establish that the target user is a registered user; the target user presenting the token for redemption; authenticating the token; and if the token is authenticated, providing the entitlement to the target user in a same session.

In another embodiment of the present invention, an expiration of the token may be different than an expiration of the entitlement corresponding to the token.

In a further embodiment of the present invention, a computer system for passing authentication between a plurality of users is disclosed. The system includes: a user environment to request an entitlement; a system environment to create a token associated with the entitlement; and a token management service coupled to the system environment to authenticate the token.

In yet a further embodiment of the present invention, the token may be passed to a target user without having to first establish that the target user is a registered user.

In a different embodiment of the present invention, if the token is authenticated by the token management system, the entitlement may be provided to the target user in a same session.

In one other embodiment, the authentication may also be used to associate the entitlement with the target user for use in subsequent sessions. In such use, the expiration period of the token could be relatively far shorter than that of the entitlement.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which certain embodiments of the present invention may be implemented;

FIG. 2 illustrates an exemplary token management system 200 in accordance with an embodiment of the present invention; and

FIG. 3 illustrates an exemplary token state diagram 300 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

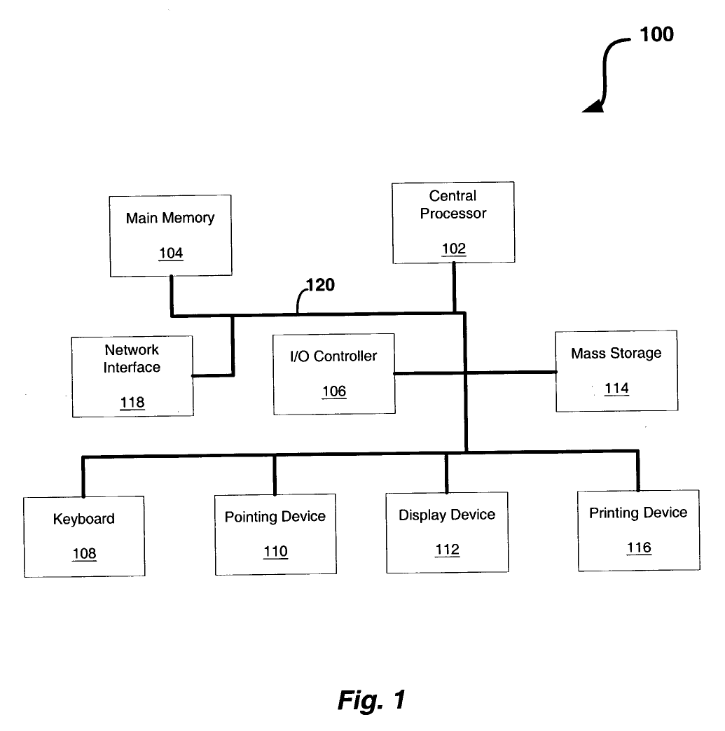

FIG. 1 illustrates an exemplary computer system 100 in which certain embodiments of the present invention may be implemented. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In accordance with an embodiment of the present invention, the computer system 100 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments of the present invention, the network interface 118 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HPUX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 100 is a general purpose computer capable of running any number of applications such as those available from companies including Oracle, Siebel, Unisys, Microsoft, and the like.

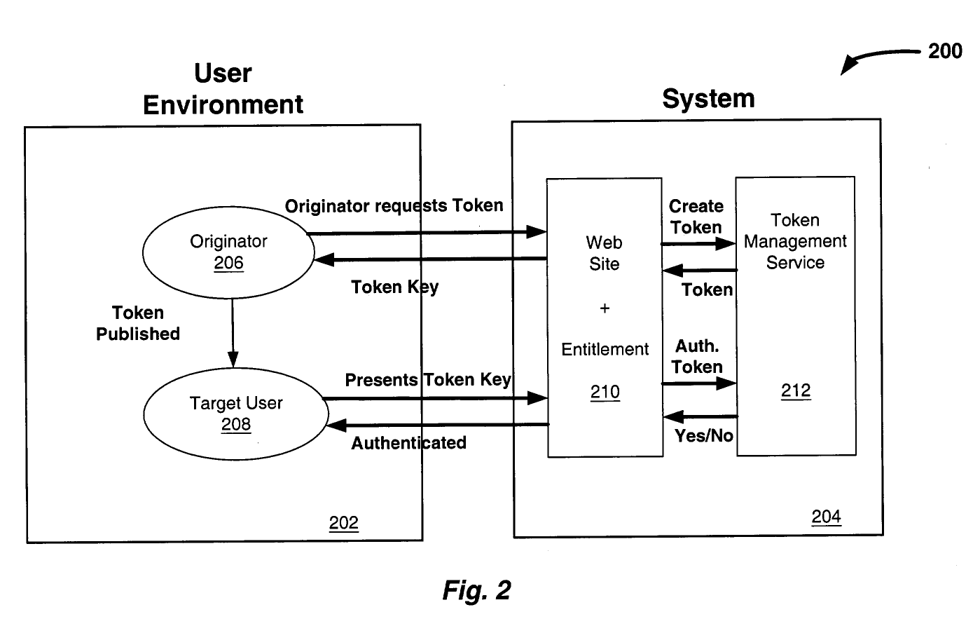

FIG. 2 illustrates an exemplary token management system 200 in accordance with an embodiment of the present invention. The system 200 includes a user environment 202 and a system environment 204. The user environment 202 and system environment 204 may be remotely located in accordance with an embodiment of the present invention (for example, on different computer servers located at different data centers). The user environment 202 includes an originator 206 (or originating user) and a target user 208 (or receiving user). The system 204 includes a website and/or an entitlement 210 and a token management service 212. In one embodiment of the present invention, the originator 206 requests a token from the website 210. The website 210 requests creation of a token from the token management service 212. The token management service 212 returns a created token to the website 210 which is then forwarded (e.g., as a token key) to the originator 206. The originator 206 may then pass the token key created by the token management service 212 to the target user 208, or otherwise utilize the token key. The target user 208 may then present the token key to the website 210 for redemption. I an alternative embodiment of the present invention, the token service may be accessed by the originator using a mechanism other than the website (e.g. a different website or computer application). For example, an employee may create tokens for publishing in a promotion.

In an embodiment of the present invention, the website 210 may authenticate the presented token by requesting authentication of the token from the token management service 212. The token management service may then respond with a yes or a no, for example, to the website 210 indicating whether the presented token is authenticated. By receiving an acknowledgement from the token management service 212, website 210 may respond to the target user 208 indicating whether the presented token key was authenticated.

In one embodiment of the present invention, the authentication discussed with respect to FIG. 2 involves the identification of a user to a system, typically so that the system can establish whether the user should have access to an entitlement (such as a purchase, a right to use, access to a user group or account (such as access to join a user group, permission to access a particular account, or functions to be performed on an account), and the like). The token key is envisioned to be the actual data (e.g., text or numbers, or otherwise binary data) passed from one user to another. The originator maybe the user who requests the creation of the token and the target user maybe the user(s) whom the originator wishes to authenticate. According, in accordance with an embodiment of the present invention, a token allows for hand off of entitlement from one user (e.g., the originator) to another user (e.g., the target user). In an alternative embodiment of the present invention, once permission to access the entitlement is granted, the entitlement may be associated with the user and the user may access the entitlement in future sessions without being required to present the token again.

In another embodiment of the present invention, the passing of authentication can be external to the system 204. For example, the token key may be published or broadcast using any mechanism that is independent of the system 204 and can pass the token key. Such external methods may include, but are not limited to, electronic mail (e-mail), telephone transmissions, voice mail, written note (e.g., handwritten and/or typed), web confirmation page, faxed transmissions, regular mail, periodic publications (such as news papers or magazines), braille, spoken words, and alike. In a further embodiment of the present invention, the token may be a database record in the system 204 that stores an association with the entitlement corresponding to the token key.

In accordance with an embodiment of the present invention, the token may include one or more of the following properties (where “->” indicates a pointer to):

token key or string (numeric/alpha-numeric code)

token type (e.g., service, invitation, and/or purchase)

feature

permissions or role

authentication identity (ID)->

service->service entitlement ID

invitation->group ID

purchase->line item ID

expiration (in an embodiment of the present invention, of the token and not the entitlement or permission created)

account of creator

usage quantity (number of times the token can be used)

token status

Accordingly, in accordance with an embodiment of the present invention, the token may have a status and may be created for one to N authentications. In a further embodiment of the present invention, the authentication ID may point to a combination of other Ids such as service, group (or permission), or line item. In one embodiment of the present invention, the token status may be selected from those discussed (as states) with respect to Table 1 below. Once all authentications are used, the token may be considered as used-up. Also, each type of token may be used within a typical timeframe, for instance a week or a month. For security reasons, a token having a specific type may expire after a given default period. It may be up to the application to determine how the time is set (for example, the application (e.g., 210) may ask the token management service 212 to set the time period differently for each type of token, or even differently for each token instance).

In a further embodiment of the present invention, it is envisioned that the expiration of the token may be different than the expiration of the entitlement corresponding to a token (or of a user's access to the entitlement once it has been authenticated). In an embodiment of the present invention, it is envisioned that the originator 206 may utilize (e.g., present) the token key to the website 210 instead of, or in addition to, the target user 208.

In one embodiment of the present invention, the originator 206 may pass the token to the target user 208 without having to first establish that the target user 208 is a registered user on the system 204. Accordingly, a user may register and gain authentication in the same session. In another embodiment of the present invention, the registration of a user who is trying to present a token key may be an optional step. It is also envisioned, in accordance with another embodiment of the present invention, that a single token may be generated for multiple target users (or for multiple entitlements) and/or multiple tokens may be generated for a same entitlement. The purchase and/or entitlement access may be associated with a user account (and persisted for future sessions in an embodiment of the present invention).

In accordance with one embodiment of the present invention, there may be three types of tokens. First, a purchase token may be utilized to pass purchaser permissions, for example, from a reseller to a purchaser. Second, a service token may allow a purchaser to pass consumption and/or other permissions to a consumer. Third, an invitation token may permit an administrator of a group to distribute membership and/or permissions to members of the group. Such tokens may include a specific role or permission and point to a specific use in an embodiment of the present invention.

In a further embodiment of the present invention, the authentication may be performed by an intermediary. For example, a service token may be generated and given to a target user. The target user might telephone a call center for service and give the token key to the call center representative as entitlement for receiving service during the call. The call center representative would then access the system, present the token key, and the system may authenticate the caller and log consumption of the token. In an alternative embodiment of the present invention, the originator 206 may be an internal employee and the token key may be distributed to customers for example for marketing promotions or as part of other bundled products purchased by customers. In a further embodiment of the present invention, the intermediary may be a reseller, agent, sales or account representatives, various customer employees, and the like.

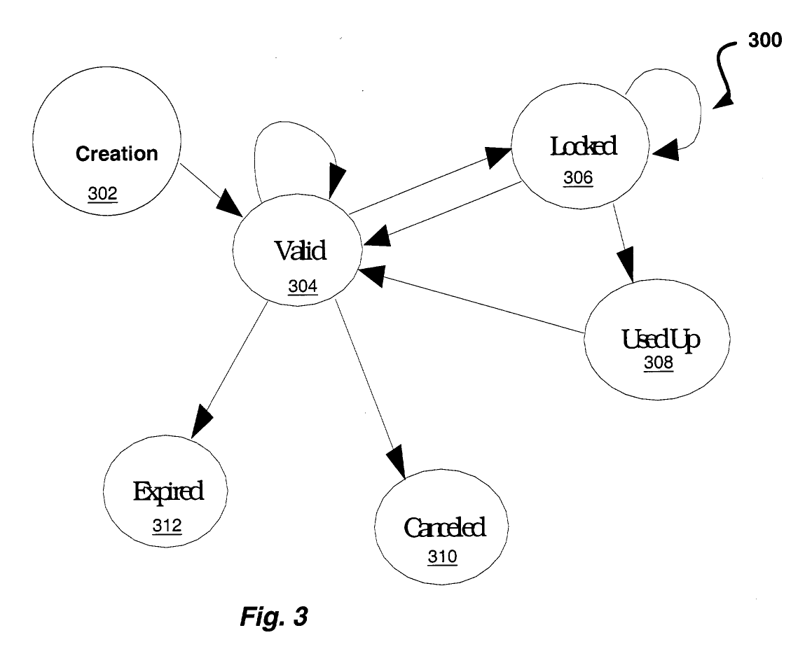

FIG. 3 illustrates an exemplary token state diagram 300 in accordance with an embodiment of the present invention. The token state diagram 300 starts at a creation stage 302 which transitions to a valid stage 304. The token state diagram 300 also includes a locked stage 306, a used up stage 308, a canceled stage 310, and an expired stage 312. In an embodiment of the present invention, the locked stage 306 may be invoked when requests and usage do not happen relatively simultaneously to, for example, ensure that no more than one user uses up the last token (since only one use should be allowed to finish). Table 1 below summarizes the transitions between the stages of FIG. 3 and the corresponding triggering events.

TABLE 1
Token State Stages

| State | | |
|---|---|---|
| (or Status) | Transition to . . . | Trigger |
| Valid | Valid | Quantity remaining more |
| | | than zero |
| | Locked | Upon a request, and |
| | | ((Quantity - number of |
| | | remaining outstanding) |
| | | equal zero) |
| | Canceled | Token Canceled |
| | Expired | Token Expires |
| Locked | Locked | Upon successful use, and |
| | | (Quantity remaining greater |
| | | than zero) |
| | Valid | Upon failed use |
| | Used Up | Upon successful use, and |
| | | (Quantity remaining equal to |
| | | zero) |
| Used Up | Valid | More added to Quantity |
| Canceled | Valid(Not likely/not shown) | Token Reinitialized |
| Expired | Valid(Not likely/not shown) | Expiration Extended |

The foregoing description has been directed to specific embodiments of the present invention. It will be apparent to those with ordinary skill in the art that modifications may be made to the described embodiments of the present invention, with the attainment of all or some of the advantages. For example, the techniques of the present invention may be utilized for provision of discounts (such as coupons, vouchers, and the like), royalty points, frequent shopping credit, and the like. Furthermore, portions of the present invention may be published or passed by either human or machine-readable medium, or both. Therefore, it is the object of the appended claims to cover all such variations and modifications as come within the spirit and scope of the invention.

What is claimed is:

1. A method of passing authentication between a plurality of users, the method comprising:
creating a token, the token having a status to indicate a state of the token;
associating the token with an entitlement;
passing the token to a target user without having to first establish that the target user is a registered user;
the target user presenting the token for redemption;
authenticating the token; and
if the token is authenticated, providing the entitlement to the target user in a same session, wherein an expiration of the token is different than an expiration of the entitlement corresponding to the token.

2. The method of claim 1 wherein the token is created for a plurality of authentications.

3. The method of claim 2 wherein once all the authentications are used, the token is used-up.

4. The method of claim 1 wherein the token status is selected from a group comprising valid, locked, used up, canceled, and expired.

5. The method of claim 1 wherein the token has one or more properties selected from a group comprising a token key, a token type, a feature, a permission, an authentication ID, an expiration, an account of creator, a usage quantity, and a token status.

6. The method of claim 5 wherein the authentication ID points to a service entitlement ID for a service type token.

7. The method of claim 5 wherein the authentication ID points to a group ID for an invitation type token.

8. The method of claim 5 wherein the authentication ID points to a line item ID for a purchase type token.

9. The method of claim 1 wherein the token has a type selected from a group comprising service, purchase, and invitation.

10. The method of claim 1 wherein a token having a specific type may expire after a given default period.

11. The method of claim 1 wherein the token is created by an originating user.

12. The method of claim 11 wherein the originating user and the target user are a same user.

13. The method of claim 1 wherein the passing is through an intermediary.

14. The method of claim 13 wherein the intermediary is selected from a group comprising a reseller, an agent, a representative, and a customer employee.

15. The method of claim 1 wherein the target user may register and gain authentication in the same session.

16. The method of claim 1 wherein the token is generated for a plurality of target users.

17. The method of claim 1 wherein a plurality of tokens are associated with the entitlement.

18. The method of claim 1 wherein the token is passed to the target user by a method selected from a group comprising Email, telephone transmission, voicemail, written note, web confirmation page, periodic publications, spoken words, and fax transmission.

19. A computer system for passing authentication between a plurality of users, the system comprising:
a user environment to request an entitlement;
a system environment to create a token associated with the entitlement, wherein an expiration of the token is different than an expiration of the entitlement corresponding to the token; and
a token management service coupled to the system environment to authenticate the token, wherein the token is passed to a target user without having to first establish that the target user is a registered user.

20. The system of claim 19 wherein if the token is authenticated by the token management system, the entitlement is provided to the target user in a same session.

21. The system of claim 19 wherein the user environment is implemented through at least a web site.

22. The system of claim 19 wherein the system environment further includes a web site to provide a communication facility between the token management service and one or more of an originating user and the target user.

23. The system of claim 19 wherein the token is created for a plurality of authentications.

24. The system of claim 19 wherein the token has a status selected from a group comprising valid, locked, used up, canceled, and expired.

25. The system of claim 19 wherein the token has one or more properties selected from a group comprising a token key, a token type, a feature, a permission, an authentication ID, an expiration, an account of creator, a usage quantity, and a token status.

26. The system of claim 19 wherein the token has a type selected from a group comprising service, purchase, and invitation.

27. The system of claim 19 wherein the token creation is requested by an originating user accessing the user environment.

28. The system of claim 27 wherein the originating user and the target user are a same user.

29. The system of claim 19 wherein the target user may register and gain authentication in a same session.

30. The system of claim 19 wherein the token is generated for a plurality of target users.

31. The system of claim 19 wherein a plurality of tokens are associated with the entitlement.

32. An apparatus for passing authentication between a plurality of users, the apparatus comprising:
means for creating a token;
means for associating the token with an entitlement;
means for passing the token to a target user without having to first establish that the target user is a registered user;
presentation means for the target user to present the token for redemption;
means for authenticating the token; and
if the token is authenticated, means for providing the entitlement to the target user in a same session

33. The apparatus of claim 32 wherein an expiration of the token is different than an expiration of the entitlement corresponding to the token.

34. An article of manufacture for passing authentication between a plurality of users, the article comprising:
a machine readable medium that provides instructions that, if executed by a machine, will cause the machine to perform operations including:
creating a token;
associating the token with an entitlement;
passing the token to a target user without having to first establish that the target user is a registered user;
the target user presenting the token for redemption;
authenticating the token; and
if the token is authenticated, providing the entitlement to the target user in a same session, wherein an expiration of the token is different than an expiration of the entitlement corresponding to the token.

35. The article of claim 34 wherein the token is created for a plurality of authentications.

36. The article of claim 34 wherein the token has a status selected from a group comprising valid, locked, used up, canceled, and expired.

37. The article of claim 34 wherein the token has one or more properties selected from a group comprising a token key, a token type, a feature, a permission, an authentication ID, an expiration, an account of creator, a usage quantity, and a token status.
